(19) United States
(12) Patent Application Publication
(10) Pub. No.: US 2024/0242261 A1
(43) Pub. Date: Jul. 18, 2024

(54) INFORMATION PROCESSING SYSTEM, INFORMATION PROCESSING METHOD, AND RECORDING MEDIUM

(71) Applicant: NEC Corporation, Tokyo (JP)

(72) Inventor: Takuro KAGOSHIMA, Tokyo (JP)

(73) Assignee: NEC Corporation, Tokyo (JP)

(21) Appl. No.: 18/399,992

(22) Filed: Dec. 29, 2023

(30) Foreign Application Priority Data
Jan. 16, 2023 (JP) 2023-004582

(51) Int. Cl. G06Q 30/0601

(52) U.S. Cl. CPC G06Q 30/0631; G06Q 30/0635

(57) ABSTRACT

An information processing system includes at least one memory configured to store instructions; and at least one processor configured to execute the instructions to: acquire product information about a product to be purchased by a customer at a store; output, to a terminal used by the customer in the store, a suggestion for regular purchase related to the product about which the product information was acquired; receive, from the terminal, an instruction to regularly purchase the product related to the suggestion; and register regular purchase of the product for which the instruction has been received.

This application is based upon and claims the benefit of priority from Japanese Patent Application No. 2023-004582, filed on Jan. 16, 2023, the disclosure of which is incorporated herein in its entirety by reference.

### TECHNICAL FIELD

The present disclosure relates to an information processing system and the like.

### BACKGROUND ART

A customer who does shopping in a store may regularly purchase the same kind of product. For a product that is regularly required, in order to prevent forgetting to buy, the product is written in a memo to be checked by a customer during shopping. It is also conceivable that the customer uses a regular purchase service of the Internet shopping for the product. When a product to be regularly purchased is delivered to the home, the customer does not need to worry about forgetting to buy the product at the store.

Japanese Patent Application Laid-open Publication No. 2007-065749 and No. 2003-256935 disclose a system that displays a questionnaire related to a product to a customer who is shopping in response to reading of a product code.

### SUMMARY

An object of the present disclosure is to provide an information processing system and the like that can reduce trouble of a customer who registers a product as a product to be regularly purchased.

An information processing system according to an aspect of the present disclosure includes at least one memory configured to store instructions, and at least one processor configured to execute the instructions to: acquire product information about a product to be purchased by a customer at a store, output, to a terminal used by the customer in the store, a suggestion for regular purchase related to the product about which the product information was acquired, receive, from the terminal, an instruction to regularly purchase the product related to the suggestion, and register regular purchase of the product for which the instruction has been received.

An information processing method according to an aspect of the present disclosure includes acquiring product information about a product to be purchased by a customer at a store, outputting, to a terminal used by the customer in the store, a suggestion for regular purchase related to the product about which the product information was acquired, receiving, from the terminal, an instruction to regularly purchase the product related to the suggestion, and registering regular purchase of the product for which the instruction has been received.

A program according to an aspect of the present disclosure causes a computer to execute the steps of acquiring product information about a product to be purchased by a customer at a store, outputting, to a terminal used by the customer in the store, a suggestion for regular purchase related to the product about which the product information was acquired, receiving, from the terminal, an instruction to regularly purchase the product related to the suggestion, and registering regular purchase of the product for which the instruction has been received. The program may be stored in a non-transitory computer-readable recording medium.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating a configuration example of an information processing system according to an example embodiment;

FIG. 2 is a diagram illustrating an example of another device communicably connected to the information processing system;

FIG. 3 is a diagram illustrating an example of a terminal;

FIG. 4 is a diagram illustrating another example of the terminal;

FIG. 5 is a diagram illustrating an example of a suggestion screen for regular purchase;

FIG. 6 is a diagram illustrating another example of a suggestion screen for regular purchase;

FIG. 7 is a diagram illustrating an example of a display screen of a delivery product list;

FIG. 8 is a diagram illustrating an example of a display screen of a shopping list;

FIG. 9 is a flowchart illustrating an operation example of the information processing system according to an example embodiment;

FIG. 10 is a block diagram illustrating another configuration example of the information processing system according to an example embodiment;

FIG. 11 is a flowchart illustrating another operation example of the information processing system according to an example embodiment;

FIG. 12 is a diagram illustrating an example of a notification screen of a registered product; and

FIG. 13 is a block diagram illustrating an example of a hardware configuration of the computer.

### EXAMPLE EMBODIMENT

### First Example Embodiment

An information processing system 100 according to an example embodiment is used to register a product to be regularly purchased by a customer. The regular purchase means that a customer regularly purchases a product. The regular purchase includes not only regularly delivering a product to a customer, but also a customer visiting a store to regularly purchase a product. In a case where the regular purchase of the product is registered, for example, the product is regularly delivered to the customer. The product to be delivered is automatically purchased. Alternatively, in a case where the regular purchase of the product is registered, a shopping memo of the product is displayed on the terminal of the customer. The shopping memo is a screen to be checked by a customer during shopping in order to prevent forgetting to buy.

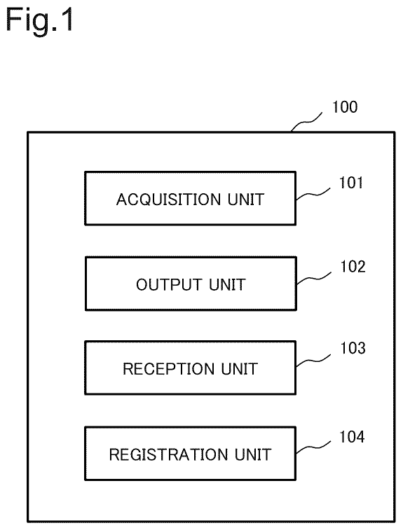

A configuration example of an information processing system 100 according to the first example embodiment will be described with reference to FIG. 1. The information processing system 100 according to the first example embodiment includes an acquisition unit 101, an output unit 102, a reception unit 103, and a registration unit 104.

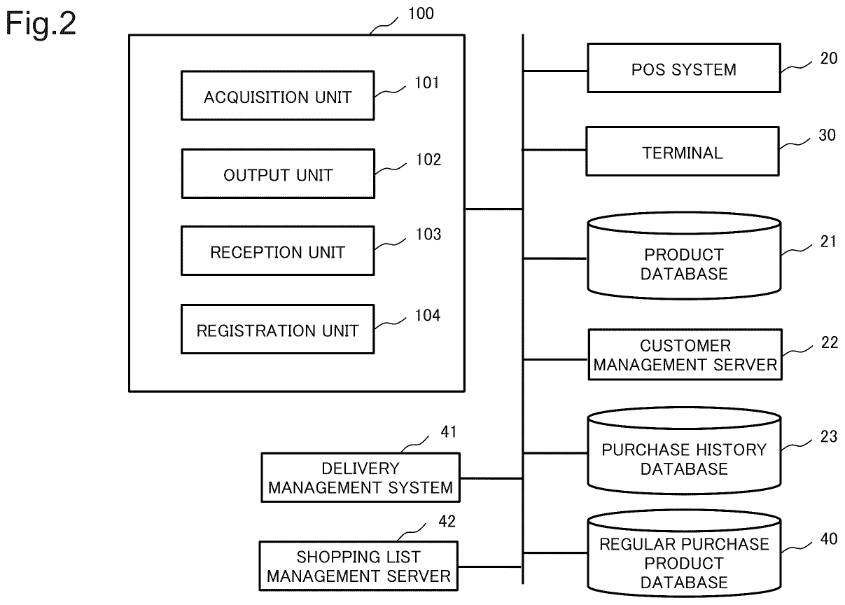

An example of another device communicably connected to the information processing system 100 will be described with reference to FIG. 2. In an example embodiment, the information processing system 100 is communicably connected to a point of sales (POS) system 20, a terminal 30, and a regular purchase product database 40. Furthermore, the information processing system 100 is connected to a product database 21, a customer management server 22, and a purchase history database 23 as necessary. The regular purchase product database 40 is communicably connected to at least one of a delivery management system 41 and a shopping list management server 42. The information processing system 100 may be connected to the delivery management system 41 or the shopping list management server 42 as necessary. A configuration example of each server and each database is an example. Each server and each database may be achieved by a single server or database in an any combination.

The POS system 20 is a system in which a customer registers a product to be purchased by a customer at a store. In an example, the POS system 20 registers a product according to an operation of a registration device operated by a customer or a store clerk in a store. However, the example of the registration of the product is not limited thereto.

The POS system 20 refers to the product database 21 and registers a product related to the barcode or tag read by the registration device. At this time, the registration device reads a barcode or a tag of a product using a scanner, a camera, or another reader. The POS system 20 may perform image recognition of a product from an image captured by the registration device and register the recognized product. At this time, the registration device images the product using the camera. The customer pays for the product registered in the POS system 20.

The terminal 30 is a terminal used by a customer in a store. The terminal 30 has a function of outputting information to the customer and a function of receiving an input of information from the customer. When the terminal 30 includes a display, the terminal 30 outputs information to the customer by displaying the information. In a case where the terminal 30 includes a speaker, the terminal 30 outputs information to the customer by sound or voice. The terminal 30 receives information input to a touch panel or a button. Alternatively, when the terminal 30 includes a microphone, the terminal 30 may receive an input of information by voice from a customer.

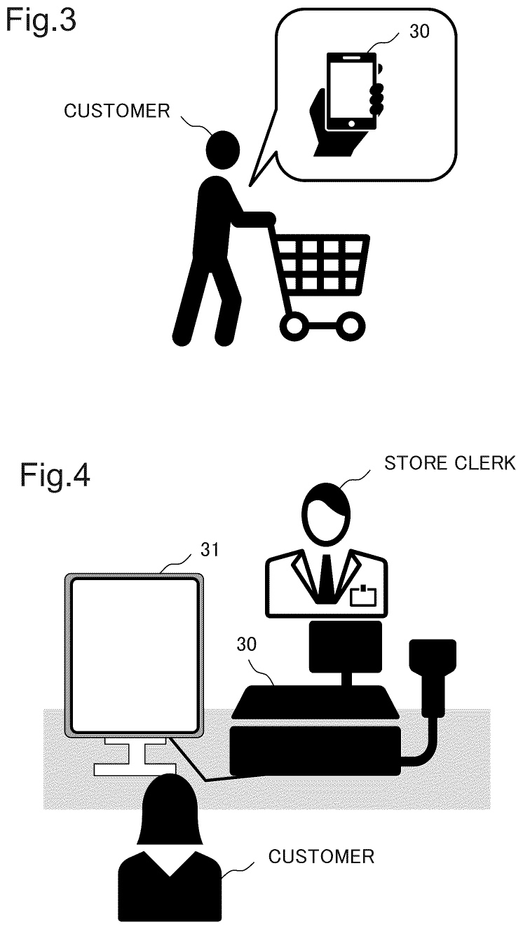

The terminal 30 may have a function of a registration device operated by a customer or a store clerk. FIGS. 3 and 4 are diagrams illustrating an example of the terminal 30. In FIG. 3, a smartphone carried by the customer functions as the terminal 30. A customer images a barcode of a product or the product itself using a smartphone. The POS system 20 registers a product in accordance with reading of a barcode based on a captured image and image recognition of the product. In FIG. 4, a cash register including a touch panel 31 for a customer, and operated by a store clerk functions as the terminal 30. POS system 20 registers a product whose barcode is read by a store clerk using a scanner. In FIG. 4, the customer operates the touch panel 31. FIGS. 3 and 4 are examples, and the terminal 30 is not limited to these examples. The terminal 30 may be a self-cash register installed in a store and operated by a customer.

The terminal 30 may be provided on a carrying tool into which a customer places a product during shopping. The carrying tool is, for example, a shopping basket or a shopping cart. The terminal 30 may be attached to a carrying tool. The terminal 30 may be formed integrally with the carrying tool. By providing the terminal 30 on the carrying tool, it is possible to output information to a customer who is shopping or receive an input of information from the customer who is shopping. In a case where the terminal 30 provided on the carrying tool has a function of the registration device, the terminal 30 may include a reader that reads a tag of a product put in the carrying tool instead of the camera. The POS system 20 registers the product put in the carrying tool. Even in a case where the terminal 30 is not provided on the carrying tool, the registration device may be provided on the carrying tool.

The product database 21 stores a product code, a product name, a price of a product, and the like for each product. For example, products of different volumes or different tastes of the same manufacturer are distinguished by the product code. The product code is, for example, a Japanese Article Number (JAN) code, a European Article Number (EAN) code, or a Universal Product Code (UPC).

The product database 21 may store a product category of each product. The manner of classifying the categories of the products is not particularly limited. The product category may be a classification of confectionery, meat, vegetables, and the like. The product category may be a classification of similar products of one or more manufacturing companies. For example, milk of a plurality of brands is classified into one product category. The product category may be a classification of products having similar capacity, taste, or price range. Products substitutable for each other may be classified into the same product category.

The customer management server 22 manages a customer identifier (ID) that uniquely identifies a customer. The customer management server 22 may manage association between the customer ID and the passcode and association between the customer ID and the biometric information about the customer.

Purchase history database 23 stores a customer purchase history of each customer. The purchase history of the customer includes a product code of a product purchased by the customer and a purchase date.

The regular purchase product database 40 stores, for each customer, a regular purchase product list of products whose regular purchase by the customer is registered. For example, the delivery management system 41 refers to the regular purchase product list in order to arrange delivery to the customer. Alternatively, shopping list management server 42 refers to the regular purchase product list in order to output a shopping memo used by the customer for shopping.

Next, each functional block of the information processing system 100 will be described. In the first example embodiment, a case where a suggestion for regular purchase is output to the customer for each product registered by the POS system 20 will be described.

The acquisition unit 101 acquires product information about a product purchased by a customer at a store. The product purchased by the customer is a product registered in the POS system 20. For example, the acquisition unit 101 acquires the product information from the POS system 20. The acquisition unit 101 may acquire the product information from the terminal 30 functioning as the registration device. The product information is information for identifying a product. The product information may be a product code for uniquely identifying a product or category information for identifying a category of a product.

The output unit 102 outputs a suggestion for regular purchase regarding the product about which the product information was acquired to the terminal 30 used by the customer in the store. In the first example embodiment, the output unit 102 outputs a suggestion for regular purchase regarding each product registered by the POS system 20. For example, the output unit 102 outputs a suggestion for registering regular delivery of a product as a suggestion for regular purchase. Alternatively, the output unit 102 outputs a suggestion for registering a product on a shopping list of products to be regularly purchased in a store as a suggestion for regular purchase.

In an example, the output unit 102 outputs a suggestion for regularly purchasing the same product as the product registered in the POS system 20. That is, in a case where the acquisition unit 101 acquires the product code as the product information, the output unit 102 may output a suggestion for regularly purchasing a product identified by the acquired product code. For example, in a case where the acquisition unit 101 acquires product information identifying milk of a predetermined brand, the output unit 102 outputs a suggestion for regularly purchasing the milk of the brand.

In another example, the output unit 102 outputs a suggestion for regularly purchasing a product included in a product category of a product registered in the POS system 20. For example, in a case where the acquisition unit 101 acquires the product code as the product information, the output unit 102 refers to the product database 21 and identifies the product category. Then, the output unit 102 outputs a suggestion related to a product included in the identified product category. When the acquisition unit 101 acquires the category information as the product information, it outputs the suggestion related to the product included in the category. The output unit 102 may output a suggestion for regular purchase of the product included in the product category in units of categories. For example, the output unit 102 outputs a suggestion for regularly purchasing milk without identifying a brand. Alternatively, the output unit 102 may output a suggestion for regular purchase of a product included in the product category on a product basis. For example, in a case where product information about milk of a specific brand is acquired, the output unit 102 may output a suggestion for regularly purchasing milk of another brand.

The output unit 102 may output a suggestion for purchasing a predetermined number of products. For example, a suggestion for regularly purchasing the same number as the number registered by the POS system 20 is output.

Output unit 102 outputs a suggestion for regular purchase to terminal 30 operated by the customer who purchases the product registered by the POS system 20.

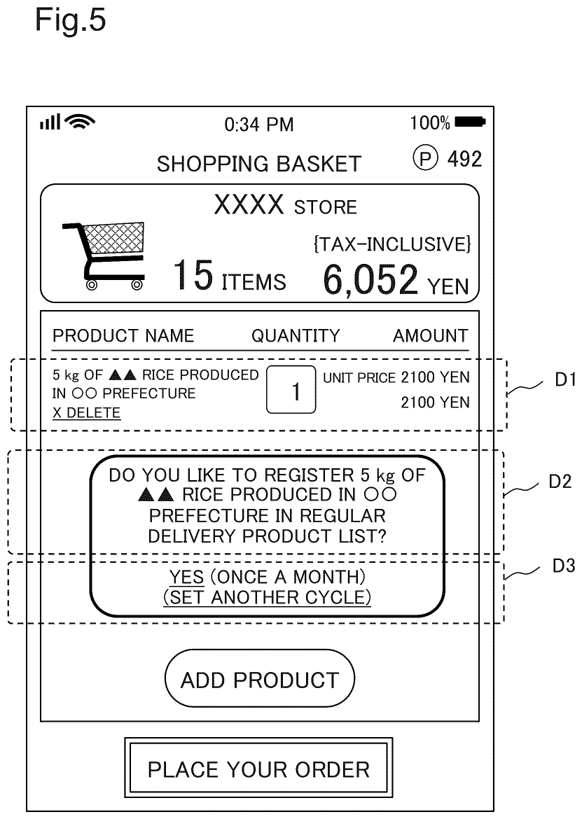

A specific example of the suggestion for regular purchase output by the terminal 30 according to the output from the output unit 102 will be described. First, as illustrated in FIG. 3, a case where a smartphone carried by a customer functions as the terminal 30 will be described as an example. FIG. 5 is a diagram illustrating an example of a suggestion screen for regular purchase displayed on the smartphone of the customer. A region D1 in FIG. 5 presents information about a product registered by the POS system 20. A region D2 in FIG. 5 presents a suggestion for regular delivery of the same product as the product registered in POS system 20.

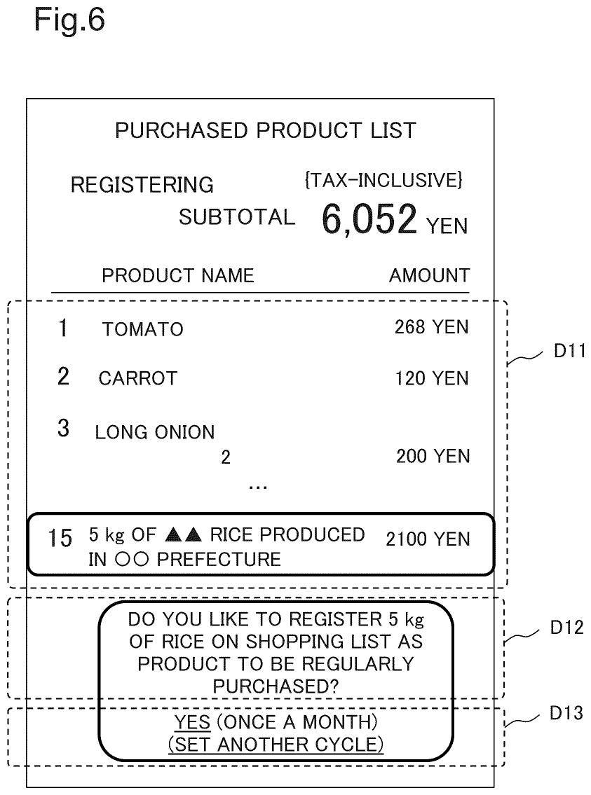

Next, as illustrated in FIG. 4, a case where the cash register including the touch panel 31 directed to the customer and operated by the store clerk functions as the terminal 30 will be described as an example. FIG. 6 is a diagram illustrating an example of a suggestion screen for regular purchase displayed on the touch panel 31 directed to a customer. A region D11 in FIG. 6 presents information about a product registered by the POS system 20. A region D12 in FIG. 6 presents a suggestion for registering a product category of a product registered in POS system 20 on a shopping list.

However, the suggestion for regular purchase output by the terminal 30 is not limited to the above example. The terminal 30 may output a suggestion of regular purchase by voice according to the output from the output unit 102 instead of the display on the screen.

The reception unit 103 receives, from the terminal 30, an instruction to regularly purchase a product related to the suggestion output by the output unit 102. For example, the reception unit 103 receives an instruction of regular purchase from the terminal 30 according to content input via a touch panel, a button, or a microphone of the terminal 30. For example, the reception unit 103 receives an instruction to regularly deliver a product as an instruction of regular purchase. Alternatively, the reception unit 103 receives an instruction to register a product in a shopping list of a product to be regularly purchased in a store as an instruction of regular purchase.

The reception unit 103 may receive an instruction of regular purchase on a product basis. Alternatively, the reception unit 103 may receive an instruction of regular purchase in units of product categories.

A specific example of input of a regular purchase instruction in the terminal 30 will be described. In the example of FIG. 5, the customer inputs an instruction of regular purchase by pressing “Yes” in a region D3 of the smartphone. In the example of FIG. 6, the customer inputs an instruction of regular purchase by pressing “Yes” in a region D13 of the touch panel.

The registration unit 104 registers regular purchase of the product for which the instruction of regular purchase is received. The registration unit 104 registers the product for which the instruction of regular purchase is received in the regular purchase product list of the regular purchase product database 40. The registration unit 104 registers a specific product identified by the product code. For example, the registration unit 104 registers regular purchase of milk of a predetermined brand. Alternatively, the registration unit 104 may register a product category. For example, the registration unit 104 registers regular purchase of milk without identifying a brand.

When the purchase quantity of the product to be regularly purchased is received by the reception unit 103, the registration unit 104 may register the received purchase quantity.

The customer ID is identified in such a way that the registration unit 104 can register the product to the regular purchase product list for each customer. The customer ID may be identified at any timing including when a product to be purchased is registered, when an instruction of regular purchase is received, or when regular purchase is registered. By identifying the customer ID, the customer is uniquely identified.

When the customer ID is stored in the member card, the terminal 30 reads the member card and identifies the customer. When the customer management server 22 manages the association between the customer ID and the passcode, the terminal 30 may receive an input of the customer ID and the passcode to transmit the input to the customer management server 22. When the combination of the customer ID and the passcode received by the customer management server 22 matches, the customer who operates the terminal 30 is identified. When the customer management server 22 manages a combination of the customer ID and the biometric information, the terminal 30 acquires the biometric information about the customer in the store to transmit the biometric information to the customer management server 22. When the biometric information received by the customer management server 22 matches the biometric information stored in association with the customer ID, the customer ID of the customer in the store is identified.

For example, terminal 30 having the function of the registration device transmits a customer ID for identifying which customer's product is registered to the POS system 20. Then, for example, the POS system 20 transmits the product information about the registered product together with the customer ID to the acquisition unit 101. Based on the customer ID received by the acquisition unit 101, the registration unit 104 registers the product in the regular purchase product list for each customer ID.

The terminal 30 may transmit an instruction of regular purchase together with the customer ID to the reception unit 103. Based on the customer ID received by the reception unit 103, the registration unit 104 registers the product in the regular purchase product list for each customer ID.

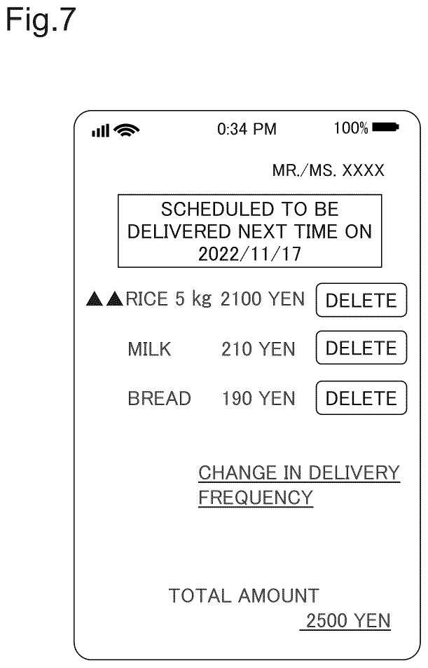

In an example, the registration unit 104 registers regular delivery of the product to the customer as the registration of the regular purchase. The delivery management system 41 refers to the regular purchase product list and arranges to deliver the product to an address associated with the customer ID. The regular purchase product list may be used as a delivery product list related to a product to be delivered. The delivery product list may be generated based on the regular purchase product list. The information processing system 100 may have the function of the delivery management system 41. FIG. 7 is a diagram illustrating an example of a display screen of a delivery product list displayed by the delivery management system 41. The delivery management system 41 displays the screen of FIG. 7 on a terminal used by a customer at an any place including a home or a store. The customer can confirm the delivery schedule of the product by viewing the screen of FIG. 7.

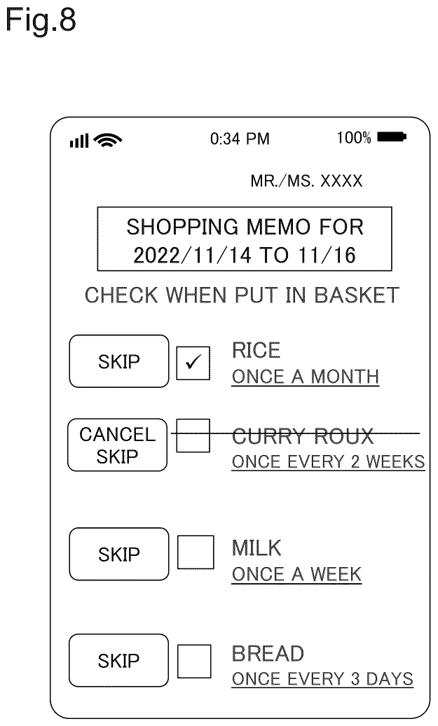

In another example, the registration unit 104 registers reminding the customer of the customer regularly purchasing a product at the store as the regular purchase registration. When the product is displayed on the shopping list checked by the customer during shopping, the customer is reminded of purchasing the product. The regular purchase product list may be used as a shopping list. The shopping list may be generated based on the regular purchase product list. The shopping list management server 42 displays the shopping list on a terminal carried by the customer. The shopping list may be displayed on the terminal 30 carried by the customer in the store. Information processing system 100 may have a function of shopping list management server 42. FIG. 8 is a diagram illustrating an example of a display screen of a shopping list. A customer puts a product into a shopping basket or the like at a store while looking at the shopping list.

The customer ID may be identified after an instruction of regular purchase is received. For example, after accounting is completed, a code indicating a list of products for which an instruction of regular purchase is received may be distributed to the customer. Then, the customer goes to the service counter in the store with the code. Then, the device of the service counter identifies the customer ID according to the operation of the customer or the store clerk. The registration unit 104 registers regular delivery of the product to the customer based on the customer ID identified by the device of the service counter.

The registration unit 104 may select one specific product identified by the product code from the products of the product category for which the instruction is received and register the selected product. For example, there is a case where there is a plurality of products of the same product category, and a customer purchases one of the plurality of products once a week. Therefore, the registration unit 104 may perform registration in such a way as to sequentially purchase products having different product codes every week in rotation. For example, the registration unit 104 may select a specific product from products included in the product category and register purchase of the selected product at a predetermined cycle.

The frequency of the regular purchase is appropriately set. As the frequency of the regular purchase, a different purchase cycle may be set for each product. For example, the registration unit 104 may register purchase of a product at a predetermined cycle such as once a month. The registration unit 104 may register the cycle designated by the user received by the reception unit 103. Alternatively, the registration unit 104 may set the cycle with reference to the purchase history database 23. The registration unit 104 may register purchase of the product at the same interval as the previous purchase cycle.

For example, according to the set frequency, the delivery management system 41 arranges to regularly deliver the product. The delivery management system 41 may display the delivery cycle of each product on the confirmation screen of the delivery product list. A shopping list is displayed to the customer according to the set cycle. For example, in a case where the customer visits the store once a week, the shopping list management server 42 displays a shopping list used by the customer for every shopping. Then, when the customer purchases a product only once a month, the product is displayed on a shopping list for shopping once a month. As illustrated in FIG. 8, the purchase cycle in which each product is registered may be displayed on the display screen of the shopping list.

When regular purchase is registered, a product discount or a point may be applied to the customer. For example, the delivery management system 41 refers to the regular purchase product list and applies a discount to the registered product. A coupon that can be used when a product is purchased at a store may be delivered to the customer. The point system (not illustrated) may refer to the purchase history database 23 and give a point to the customer when a product registered in the regular purchase product list has been purchased. Therefore, the customer can purchase the product at a lower price as compared with the case of purchasing the product without registering the regular purchase. As a result, the customer can obtain an advantage of registering a product to be regularly purchased.

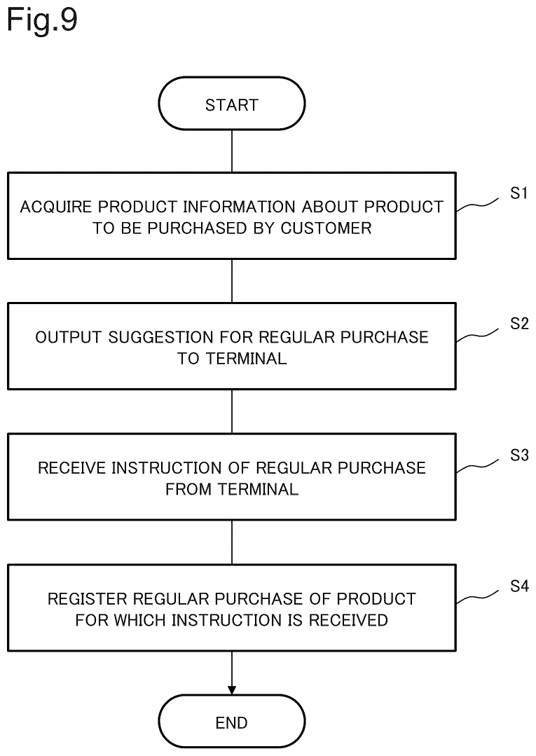

An operation example of the information processing system 100 according to the first example embodiment will be described with reference to FIG. 9. For example, the information processing system 100 may start the process of FIG. 9 in response to registration of the product to be purchased by the customer by the POS system 20.

The acquisition unit 101 acquires the product information about the product to be purchased by the customer at the store (step S1). The output unit 102 outputs a suggestion for regular purchase related to the product about which the product information is acquired by the acquisition unit 101 to the terminal 30 used by the customer in the store (step S2). The information processing system 100 may execute steps S1 and S2 each time the POS system 20 newly registers a product. That is, the acquisition unit 101 acquires product information about a newly registered product, and the output unit 102 outputs a suggestion for regular purchase regarding the product.

The reception unit 103 receives, from the terminal 30, an instruction to regularly purchase a product related to the suggestion output by the output unit 102 (step S3). The registration unit 104 registers regular purchase of the product for which the instruction of regular purchase is received (step S4). After the execution of step S4, the information processing system 100 ends the process of FIG. 9.

In a case where step S3 is not executed after a lapse of a certain time from the execution of step S2, the information processing system 100 may end the process of FIG. 9. In a case where the POS system 20 ends the registration of the product to be purchased by the customer after execution of step S2, the information processing system 100 may end the process of FIG. 9.

It may be troublesome for the customer to register regular purchase of the product.

According to an example embodiment, the acquisition unit 101 acquires the product information about the product to be purchased by the customer at the store, and the output unit 102 outputs a suggestion for regular purchase regarding the product to the terminal 30 used by the customer in the store. Then, the reception unit 103 receives, from the terminal 30, an instruction to regularly purchase a product related to the output suggestion, and the registration unit 104 registers regular purchase of the product for which the instruction of regular purchase is received.

Therefore, the customer can register regular purchase of a product while in the store. Then, the customer does not need to perform the product registration operation after returning home. The customer can save time and effort to search for a product to be registered for regular purchase. Therefore, according to an example embodiment, it is possible to reduce the trouble of the customer who registers the product as the product to be regularly purchased. According to an example embodiment, the regular purchase of the product is easily registered in such a way that the product can be regularly delivered or displayed on the shopping memo. Therefore, it is possible to reduce the trouble of the customer who takes measures to prevent the customer from forgetting to buy the product.

### Second Example Embodiment

In the first example embodiment, the case where the information processing system 100 outputs a suggestion for regular purchase of each product registered by the POS system 20 is described. Hereinafter, a second example embodiment in which the information processing system 100 outputs a suggestion for regular purchase of a product for which regular purchase is recommended will be described. In the description of the configuration of the second example embodiment, the description of the same configuration as that of the first example embodiment is omitted.

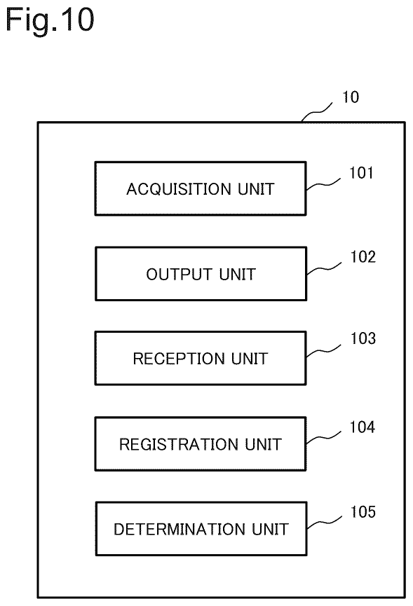

A configuration example of the information processing system 100 according to the second example embodiment will be described with reference to FIG. 10. A determination unit 105 determines whether the regular purchase of the product about which the product information is acquired is suggested. The determination unit 105 determines to suggest the regular purchase of the product for which the regular purchase is recommended. Determination unit 105 may determine whether to suggest the regular purchase based on the purchase history of the customer. The purchase history of the customer includes a product code of a product purchased by the customer and a purchase date. Determination unit 105 refers to the purchase history database 23. Then, in a case where the customer purchases a product at a predetermined frequency, the determination unit 105 determines to suggest regular purchase of the product.

Determination unit 105 may determine whether to suggest the regular purchase based on the weight of the product. The weight of the product may be stored in the product database 21 in association with the product code. The determination unit 105 may refer to the product database 21 and determine whether the weight of the product about which the product information was acquired exceeds a predetermined threshold value. The weight of the product may be included in the product name. Therefore, determination unit 105 may estimate the weight of the product based on the product name acquired by the acquisition unit 101. In a case where the weight of the product exceeds a predetermined threshold value, the determination unit 105 determines to suggest regular purchase of the product. As a result, the information processing system 100 can determine that, for example, it is recommended to regularly deliver a heavy product to home.

The method of determining the product for which the regular purchase is suggested is not limited to the above. The determination unit 105 may refer to a database that stores in advance a product for which regular purchase is suggested, and determine that the regular purchase is suggested for the product included in the database.

In the second example embodiment, the output unit 102 outputs a suggestion for regular purchase regarding the product for which the determination unit 105 has determined to suggest the regular purchase.

The determination unit 105 may determine whether to suggest regular purchase of a product included in the product category of the product about which the product information was acquired. In this case, the output unit 102 outputs a suggestion for regular purchase of a product included in the product category. The determination unit 105 may determine whether to suggest regular purchase in units of categories. Alternatively, the determination unit 105 may determine whether to suggest regular purchase of a specific product included in the category.

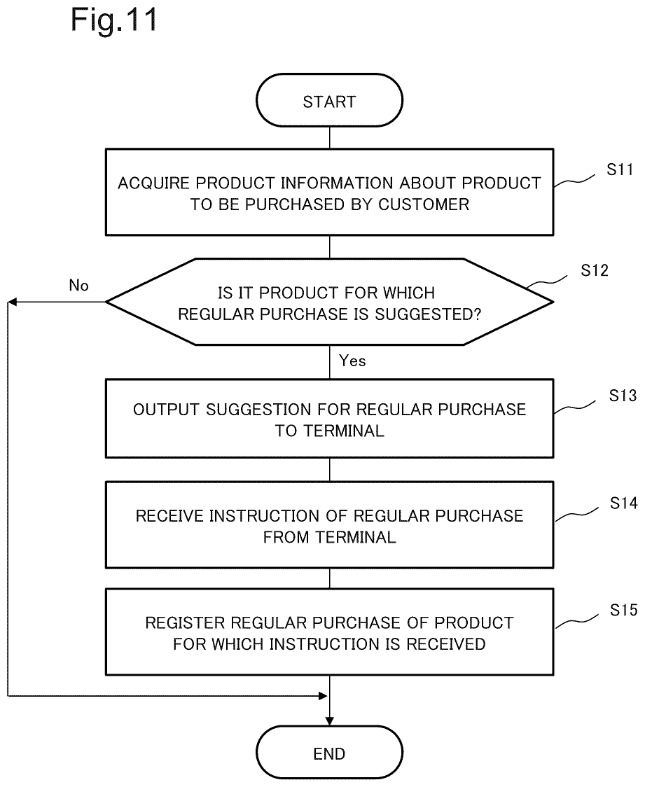

The operation according to the second example embodiment is basically similar to that of the first example embodiment. An operation example of the information processing system 100 according to the second example embodiment will be described with reference to FIG. 11. For example, the information processing system 100 may start the process of FIG. 11 in response to registration of the product to be purchased by the customer by the POS system 20.

The acquisition unit 101 acquires the product information about the product to be purchased by the customer at the store (step S11). Determination unit 105 determines whether to suggest regular purchase of the product about which the product information is acquired (step S12). In a case where the determination unit 105 determines that the product is a product for which regular purchase is suggested (step S12: Yes), the information processing system 100 executes step S13. That is, the output unit 102 outputs the suggestion for regular purchase related to the product for which the regular purchase is recommended to the terminal 30 used by the customer in the store (step S13). In a case where the determination unit 105 determines that the product is not a product for which the regular purchase is suggested (step S12: Yes), the information processing system 100 ends the process of FIG. 11. Information processing system 100 may execute steps S11, and S12 each time the POS system 20 newly registers a product.

After step S13, the reception unit 103 receives, from the terminal 30, an instruction to regularly purchase a product related to the suggestion output by the output unit 102 (step S14). The registration unit 104 registers the regular purchase of the product for which the instruction of regular purchase is received (step S15). After the execution of step S15, the information processing system 100 ends the process of FIG. 11.

According to the second example embodiment, the determination unit 105 determines whether to suggest regular purchase of a product the product information about which was acquired. Then, the output unit 102 outputs a suggestion for regular purchase regarding the product. Therefore, the amount of information presented to the customer can be reduced as compared with the case where the suggestion for regular purchase is output for all the products the product information about which was acquired. It is possible to output a suggestion for registration of regular purchase to a customer who may need the regular purchase.

[Modifications]

The above example embodiment may be modified and used. The modifications will be described below.

In the above example embodiment, the case where the POS system 20 registers a product according to an operation of a store clerk or a customer is described. The POS system 20 may perform image recognition of a product from an image captured by a camera installed in a store, and register the recognized product. POS system 20 identifies the customer ID at an any timing while the customer is in the store. Then, the POS system 20 recognizes a product put in a bag or a product picked up by a customer by image recognition. Thereafter, the POS system 20 registers the recognized product as a product to be purchased by the customer. As in the above example embodiment, the output unit 102 outputs the suggestion for regular purchase to the terminal 30 operated by the customer who purchases the product registered by the POS system 20.

In such a case, a smartphone carried by the customer can function as the terminal 30. For example, the customer presents a customer ID when entering a store. Then, the output unit 102 outputs a suggestion for regular purchase to the terminal 30 associated with the customer ID. The terminal 30 may be installed near a display shelf or near an exit in the store. In a case where it is detected by presentation of the customer ID, biometric authentication, or traffic line tracking that the customer approaches the terminal 30, the output unit 102 outputs a suggestion for regular purchase to the terminal 30. The terminal 30 installed near the exit may be a terminal that confirms the product to be purchased by the customer when the customer leaves the store.

Next, a modification in a case where the information processing system 100 registers regular delivery of a product to a customer will be described.

The customer may erroneously purchase the product at the store scheduled to be delivered. Therefore, the output unit 102 may output a notification to the terminal 30 in a case where the user intends to purchase a product registered in the regular purchase product list. For example, the acquisition unit 101 acquires product information about a product to be purchased by a customer at a store. The determination unit 105 refers to the regular purchase product list and determines whether the product is registered. Then, in a case where the product about which the product information was acquired is registered in the regular purchase product list, the output unit 102 outputs a notification indicating that the product is registered to the terminal 30.

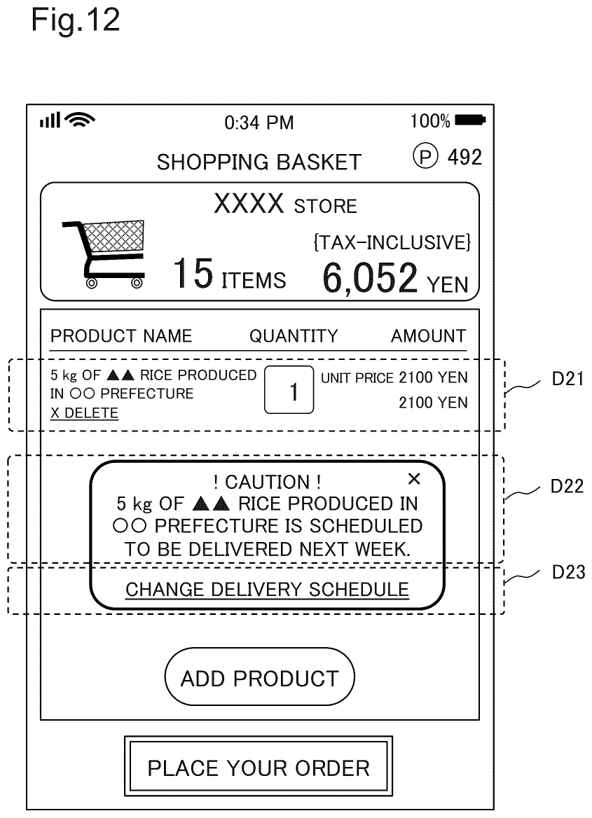

A specific example of the notification output by the terminal 30 will be described. As illustrated in FIG. 3, a case where a smartphone carried by a customer functions as the terminal 30 will be described as an example. FIG. 12 is a diagram illustrating an example of a notification screen in a case where a customer intends to purchase a product registered in the regular purchase product list. A region D21 in FIG. 12 presents information about a product registered by the POS system 20. A region D22 in FIG. 12 makes a notification that the product registered in POS system 20 is registered in the purchase product list. The screen similar to that in FIG. 12 may be output to the terminal 30 which is a touch panel directed to the customer in the cash register.

Even in a case where the product is scheduled to be delivered, the customer may wish to purchase the product at the store before the delivery. Therefore, the output unit 102 may display a button for changing the delivery schedule on the terminal 30. For example, as illustrated in a region D23 of FIG. 12, the terminal 30 displays a delivery schedule change button on the notification screen of the registered product. When the customer presses the change button, the output unit 102 displays a screen for performing an operation of canceling the next delivery of the product. Alternatively, the output unit 102 displays a screen for performing an operation of reducing the frequency of delivery.

The delivery management system 41 may display a suggestion for purchasing a product different from the product to be regularly delivered on the display screen of the delivery product list. For example, the delivery management system 41 suggests purchase of a product similar to a product registered in the regular purchase product list. The similar product is, for example, another product included in the same product category: The customer may view the suggestion, perform an operation, and change the delivery schedule. The suggestion to purchase another product may be displayed by the output unit 102 of the information processing system 100.

Next, a modification in a case where the information processing system 100 registers reminding the customer of the customer regularly purchasing a product at a store will be described.

The output unit 102 may output the notification in such a way that the customer does not forget to buy the product, at the store, whose regular purchase is registered. For example, the output unit 102 may output, to the terminal 30, a notification regarding a product registered in the regular purchase product list based on the position information in the store of the customer. The position of the customer in the store is acquired by any method. For example, the position of the customer in the store may be tracked by the terminal 30 operated by the customer wirelessly communicating with a device installed in the store. When the customer approaches a display place of a registered product, the output unit 102 may output a notification related to the product. The output unit 102 may display a notification related to a product registered in the regular purchase product list on the display screen of the shopping list displayed by the shopping list management server 42.

Even in a case where regular purchase of a specific product by the customer is registered, the store may want the customer to purchase another similar product. For example, there are a case where the store desires to promote a specific product, a case where the store ends the handling of the product, and the like. Therefore, the output unit 102 may output a suggestion for purchasing a similar product at a store to the terminal 30. The similar product is, for example, another product included in the same product category as the product registered in the regular purchase product list. The output unit 102 may output a suggestion for purchasing a similar product in the store based on the position of the customer in the store. For example, the output unit 102 may output a suggestion in a case where a customer approaches a display place of a similar product. The output unit 102 may display on the terminal 30 both the notification related to the product registered in the regular purchase product list and the suggestion for purchasing a similar product. As a result, the store can suggest a change in the product to be purchased to the customer.

Even when a product is registered to be regularly purchased, the customer may not purchase the product on the store visit date. The shopping list management server 42 may receive a registration request that the product is not purchased on that day. For example, when the skip button illustrated in FIG. 8 is pressed, the shopping list management server 42 receives a registration request for not purchasing a product. On the display screen of the shopping list, the shopping list management server 42 displays a cancellation line for the product registered as not to be purchased by the customer.

In a case where the customer performs registration not to purchase the product on that day, it is conceivable that the purchase frequency of the product registered by the registration unit 104 is too high. Therefore, in a case where the registration request for not purchasing the product is received, the output unit 102 may output a suggestion for changing the purchase frequency of the product to the terminal 30. In a case where the customer inputs that the customer responds to the suggestion, the output unit 102 may output a screen on which a new cycle can be input in such a way as to reduce the frequency of purchase. The reception unit 103 receives the input cycle, and the registration unit 104 registers a new purchase cycle.

[Hardware Configuration]

In each of the above-described example embodiments, each component of the information processing system 100 indicates a block of a functional unit. Some or all of the components of the information processing system 100 may be achieved by an any combination of the computer 500 and a program.

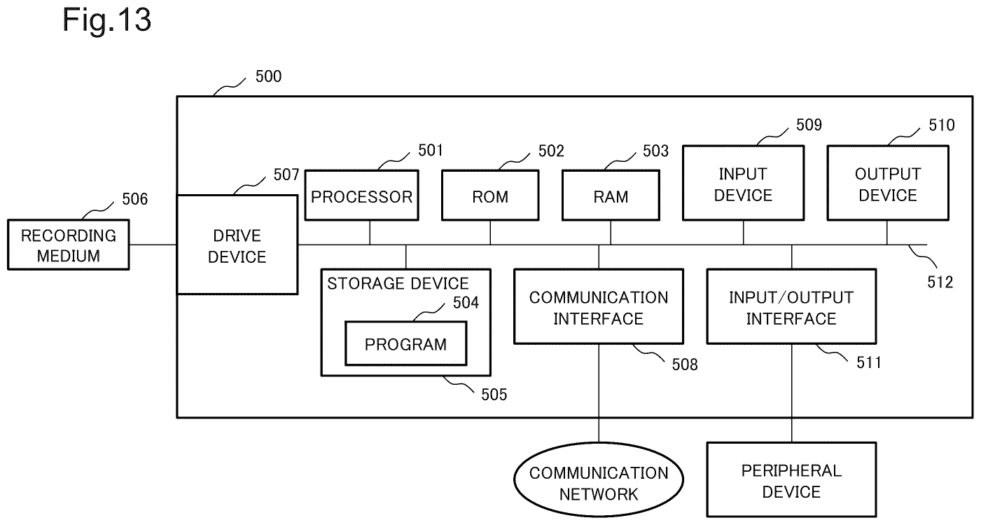

FIG. 13 is a block diagram illustrating an example of a hardware configuration of the computer 500. Referring to FIG. 13, the computer 500 includes, for example, a processor 501, a read only memory (ROM) 502, a random access memory (RAM) 503, a program 504, a storage device 505, a drive device 507, a communication interface 508, an input device 509, an input/output interface 511, and a bus 512.

The processor 501 controls the entire computer 500. Examples of the processor 501 include a central processing unit (CPU) and the like. The number of processors 501 is not particularly limited, and the number of processors 501 is one or more.

The program 504 includes a command (instruction) for implementing each function of the information processing system 100. The program 504 is stored in advance in the ROM 502, the RAM 503, and the storage device 505. The processor 501 implements each function of the information processing system 100 by executing instructions included in the program 504. For example, the processor 501 of the information processing system 100 executes a command included in the program 504 to implement the function of the information processing system 100. The RAM 503 may store data to be processed by each function of the information processing system 100.

The drive device 507 reads and writes the recording medium 506. The communication interface 508 provides an interface with a communication network. The input device 509 is, for example, a mouse, a keyboard, or the like, and receives an input of information from an administrator or the like. The output device 510 is, for example, a display, and outputs (displays) information to an administrator or the like. The input/output interface 511 provides an interface with a peripheral device. The bus 512 connects the components of the hardware. The program 504 may be supplied to the processor 501 via a communication network, or may be stored in the recording medium 506 in advance, read by the drive device 507, and supplied to the processor 501.

The hardware configuration illustrated in FIG. 13 is an example, and other components may be added or some components may not be included.

There are various modifications of the method of achieving the information processing system 100. For example, the information processing system 100 may be achieved by any combinations of a computer and a program different for each component. A plurality of components included in the information processing system 100 may be achieved by any combinations of one computer and a program. The components of the information processing system 100 may be incorporated in a computer and a program that implement the POS system 20.

At least part of the information processing system 100 may be provided in a software as a service (SaaS) format. That is, at least some of the functions for achieving the information processing system 100 may be executed by software executed via a network.

Although the present disclosure is described with reference to the exemplary example embodiments, the present disclosure is not limited to the exemplary example embodiments. Various modifications that can be understood by those of ordinary skill in the art can be made to the configuration and details of the present disclosure within the scope of the present disclosure. The configurations in the respective example embodiments can be combined with each other without departing from the scope of the present disclosure.

Further, it is noted that the inventor's intent is to retain all equivalents of the claimed invention even if the claims are amended during prosecution.

Supplementary Note

Some or all of the above example embodiments may be described as the following Supplementary Notes, but are not limited to the following.

### [Supplementary Note 1]

An information processing system including
an acquisition means configured to acquire product information about a product to be purchased by a customer at a store,
an output means configured to output, to a terminal used by the customer in the store, a suggestion for regular purchase related to the product about which the product information was acquired,
a reception means configured to receive, from the terminal, an instruction to regularly purchase the product related to the suggestion, and
a registration means configured to register regular purchase of the product for which the instruction has been received.

### [Supplementary Note 2]

The information processing system according to Supplementary Note 1, further including
a determination means configured to determine whether to suggest regular purchase of the product about which the product information is acquired, wherein
the output means outputs a suggestion for regular purchase regarding the product, the regular purchase being determined to be suggested.

### [Supplementary Note 3]

The information processing system according to Supplementary Note 2, wherein
the determination means determines whether to suggest regular purchase of the product based on a purchase history of the customer.

### [Supplementary Note 4]

The information processing system according to any one of Supplementary Notes 1 to 3, wherein
the output means outputs a suggestion for the regular purchase regarding a product included in a product category in units of product categories, the product category including the product about which the product information is acquired.

### [Supplementary Note 5]

The information processing system according to any one of Supplementary Notes 1 to 4, wherein
the registration means registers regular delivery, to the customer, of the product for which the instruction has been received.

### [Supplementary Note 6]

The information processing system according to Supplementary Note 5, wherein
the output means outputs, when product information about the product whose regular delivery is registered is acquired, a notification to the terminal.

### [Supplementary Note 7]

The information processing system according to any one of Supplementary Notes 1 to 6, wherein
the registration means registers reminding the customer of the customer regularly purchasing, at the store, the product for which the instruction has been received.

### [Supplementary Note 8]

The information processing system according to Supplementary Note 7, wherein
the output means outputs, to the terminal, a suggestion for purchasing, at the store, a product similar to the product for which reminding of regularly purchasing the product at the store is registered.

### [Supplementary Note 9]

The information processing system according to Supplementary Note 7 or 8, wherein
the output means outputs, to the terminal, a notification regarding the product for which reminding of regularly purchasing the product at the store based on a position of the customer in the store.

### [Supplementary Note 10]

The information processing system according to any one of Supplementary Notes 7 to 9, wherein
the output means outputs, to the terminal, a suggestion for purchasing, at the store, a product similar to the product for which reminding of regularly purchasing the product at the store based on a position of the customer in the store.

### [Supplementary Note 11]

The information processing system according to Supplementary Note 2 or 3, wherein
the determination means determines whether to suggest regular purchase of the product based on a weight of the product about which the product information is acquired.

### [Supplementary Note 12]

The information processing system according to Supplementary Note 4, wherein
the registration means selects a specific product among products included in the product category and register regular purchase of the selected product.

### [Supplementary Note 13]

The information processing system according to any one of Supplementary Notes 1 to 12, wherein
the terminal includes a smartphone, or a terminal provided on a shopping basket or a shopping cart.

### [Supplementary Note 14]

The information processing system according to any one of Supplementary Notes 1 to 13, wherein
the acquisition means acquires the product information about the product read using a smartphone, or a registration device provided on a shopping basket or a shopping cart.

### [Supplementary Note 15]

An information processing method including
acquiring product information about a product to be purchased by a customer at a store,
outputting, to a terminal used by the customer in the store, a suggestion for regular purchase related to the product about which the product information was acquired,
receiving, from the terminal, an instruction to regularly purchase the product related to the suggestion, and
registering regular purchase of the product for which the instruction has been received.

### [Supplementary Note 16]

A program for causing a computer to execute the steps of
acquiring product information about a product to be purchased by a customer at a store,
outputting, to a terminal used by the customer in the store, a suggestion for regular purchase related to the product about which the product information was acquired,
receiving, from the terminal, an instruction to regularly purchase the product related to the suggestion, and
registering regular purchase of the product for which the instruction has been received.

1. An information processing system comprising:
at least one memory configured to store instructions; and
at least one processor configured to execute the instructions to:
acquire product information about a product to be purchased by a customer at a store;
output, to a terminal used by the customer in the store, a suggestion for regular purchase related to the product about which the product information was acquired;
receive, from the terminal, an instruction to regularly purchase the product related to the suggestion; and
register regular purchase of the product for which the instruction has been received.

2. The information processing system according to claim 1, wherein the at least one processor is further configured to execute the instructions to:
determine whether to suggest regular purchase of the product about which the product information is acquired; and
output a suggestion for the regular purchase regarding the product, the regular purchase being determined to be suggested.

3. The information processing system according to claim 2, wherein the at least one processor is further configured to execute the instructions to:
determine whether to suggest regular purchase of the product based on a purchase history of the customer.

4. The information processing system according to claim 1, wherein the at least one processor is further configured to execute the instructions to:
output a suggestion for the regular purchase regarding a product included in a product category in units of product categories, the product category including the product about which the product information is acquired.

5. The information processing system according to claim 1, wherein the at least one processor is further configured to execute the instructions to:
register regular delivery, to the customer, of the product for which the instruction has been received.

6. The information processing system according to claim 5, wherein the at least one processor is further configured to execute the instructions to:
when product information about the product whose regular delivery is registered is acquired, output a notification to the terminal.

7. The information processing system according to claim 1, wherein the at least one processor is further configured to execute the instructions to:
register reminding the customer of the customer regularly purchasing, at the store, the product for which the instruction has been received.

8. The information processing system according to claim 7, wherein the at least one processor is further configured to execute the instructions to:
output, to the terminal, a suggestion for purchasing, at the store, a product similar to the product for which reminding of regularly purchasing the product at the store is registered.

9. The information processing system according to claim 7, wherein the at least one processor is further configured to execute the instructions to:
output, to the terminal, a notification regarding the product for which reminding of regularly purchasing the product at the store based on a position of the customer in the store.

10. The information processing system according to claim 7, wherein the at least one processor is further configured to execute the instructions to:
output, to the terminal, a suggestion for purchasing, at the store, a product similar to the product for which reminding of regularly purchasing the product at the store based on a position of the customer in the store.

11. The information processing system according to claim 2, wherein the at least one processor is further configured to execute the instructions to:
determine whether to suggest regular purchase of the product based on a weight of the product about which the product information is acquired.

12. The information processing system according to claim 4, wherein the at least one processor is further configured to execute the instructions to:
select a specific product among products included in the product category and register regular purchase of the selected product.

13. The information processing system according to claim 1, wherein the terminal includes a smartphone, or a terminal provided on a shopping basket or a shopping cart.

14. The information processing system according to claim 1, wherein the at least one processor is further configured to execute the instructions to:
acquire the product information about the product read using a smartphone, or a registration device provided on a shopping basket or a shopping cart.

15. An information processing method comprising:
acquiring product information about a product to be purchased by a customer at a store;
outputting, to a terminal used by the customer in the store, a suggestion for regular purchase related to the product about which the product information was acquired;
receiving, from the terminal, an instruction to regularly purchase the product related to the suggestion; and
registering regular purchase of the product for which the instruction has been received.

16. A non-transitory computer-readable recording medium that records a program for causing a computer to execute:
acquiring product information about a product to be purchased by a customer at a store;
outputting, to a terminal used by the customer in the store, a suggestion for regular purchase related to the product about which the product information was acquired;
receiving, from the terminal, an instruction to regularly purchase the product related to the suggestion; and
registering regular purchase of the product for which the instruction has been received.
